(19) United States
(12) Patent Application Publication
(10) Pub. No.: US 2016/0351204 A1
(43) Pub. Date: Dec. 1, 2016

(54) Method and Apparatus for Processing Speech Signal According to Frequency-Domain Energy

(71) Applicant: Huawei Technologies Co., Ltd., Shenzhen (CN)

(72) Inventor: Lijing Xu, Shenzhen (CN)

(21) Appl. No.: 15/237,095

(22) Filed: Aug. 15, 2016

Related U.S. Application Data
(63) Continuation of application No. PCT/CN2014/088654, filed on Oct. 15, 2014.

(30) Foreign Application Priority Data
Mar. 17, 2014 (CN) 201410098869.4

(51) Int. Cl. G10L 21/0308; G10L 25/18; G10L 25/06

(52) U.S. Cl. CPC G10L 21/0308; G10L 25/06; G10L 25/18

(57) ABSTRACT

A method and an apparatus for processing a speech signal according to frequency-domain energy where the method and apparatus include receiving an original speech signal including a first speech frame and a second speech frame that are adjacent to each other, performing a Fourier transform on the first speech frame and the second speech frame, obtaining a frequency-domain energy distribution of the first speech frame and the second speech frame, obtaining a frequency-domain energy correlation coefficient, and segmenting the original speech signal according to the frequency-domain energy correlation coefficient. Hence a problem that a speech signal segmentation result has low accuracy due to a characteristic of a phoneme of a speech signal or severe impact of noise when refined speech signal segmentation is performed may be resolved.

### CROSS-REFERENCE TO RELATED APPLICATIONS

This application is a continuation of International Application No. PCT/CN2014/088654, filed on Oct. 15, 2014, which claims priority to Chinese Patent Application No. 201410098869.4, filed on Mar. 17, 2014, both of which are hereby incorporated by reference in their entireties.

### TECHNICAL FIELD

Embodiments of the present disclosure relate to speech signal processing technologies, and in particular, to a method and an apparatus for processing a speech signal according to frequency-domain energy.

### BACKGROUND

When quality assessment or speech recognition is performed on a speech signal, refined segmentation usually needs to be performed on the speech signal.

In the prior art, segmentation on a speech signal is mainly to analyze a situation of a sudden change of time-domain energy in the speech signal, and perform segmentation on the speech signal according to a time change point at which the sudden change of the energy occurs. Segmentation is not performed on the speech signal when there is no change of the energy occurs.

However, a sudden change of time-domain energy does not necessarily occur when the speech signal changes, due to a characteristic of a phoneme or impact of relatively strong noise. Therefore, a speech signal segmentation result in the prior art has low accuracy.

### SUMMARY

Embodiments of the present disclosure provide a method and an apparatus for processing a speech signal according to frequency-domain energy in order to resolve a problem that a speech signal segmentation result has low accuracy due to a characteristic of a phoneme of a speech signal or severe impact of noise when refined segmentation is performed on the speech signal.

According to a first aspect, the present disclosure provides a method for processing a speech signal according to frequency-domain energy, including receiving an original speech signal, where the original speech signal includes a first speech frame and a second speech frame that are adjacent to each other, performing a Fourier transform on the first speech frame to obtain a first frequency-domain signal, and performing a Fourier transform on the second speech frame to obtain a second frequency-domain signal, obtaining a frequency-domain energy distribution of the first speech frame according to the first frequency-domain signal, and obtaining a frequency-domain energy distribution of the second speech frame according to the second frequency-domain signal, where the frequency-domain energy distribution represents an energy distribution characteristic of the speech frame in a frequency domain, obtaining a frequency-domain energy correlation coefficient between the first speech frame and the second speech frame according to the frequency-domain energy distribution of the first speech frame and the frequency-domain energy distribution of the second speech frame, where the frequency-domain energy correlation coefficient is used to represent a spectral change from the first speech frame to the second speech frame, and segmenting the original speech signal according to the frequency-domain energy correlation coefficient.

With reference to the first aspect, in a first implementation manner, a frequency range of the first speech frame includes at least two frequency bands, where obtaining a frequency-domain energy distribution of the first speech frame according to the first frequency-domain signal further includes obtaining a first ratio of total energy within any one of the frequency bands of the first speech frame to total energy of the first speech frame according to a real part of the first frequency-domain signal and an imaginary part of the first frequency-domain signal, and performing derivation on the first ratio to obtain a first derivative that represents the frequency-domain energy distribution of the first speech frame.

With reference to the first aspect and the first implementation manner, in a second implementation manner, obtaining a frequency-domain energy correlation coefficient between the first speech frame and the second speech frame according to the frequency-domain energy distribution of the first speech frame and the frequency-domain energy distribution of the second speech frame further includes determining the frequency-domain energy correlation coefficient between the first speech frame and the second speech frame according to the first derivative within the frequency range of the first speech frame, a second derivative, and a product of the first derivative and the second derivative, where the second derivative represents the frequency-domain energy distribution of the second speech frame.

With reference to the first aspect and the first two implementation manners, in a third implementation manner, after obtaining a frequency-domain energy correlation coefficient between the first speech frame and the second speech frame according to the frequency-domain energy distribution of the first speech frame and the frequency-domain energy distribution of the second speech frame, the method further includes determining a local maximum point of the frequency-domain energy correlation coefficient, grouping the original speech signal using the local maximum point as a grouping point, and performing normalization processing on each group obtained by grouping, and calculating a corrected frequency-domain energy correlation coefficient according to the frequency-domain energy correlation coefficient and a result of the normalization processing, and correspondingly, segmenting the original speech signal according to the frequency-domain energy correlation coefficient includes segmenting the original speech signal according to the corrected frequency-domain energy correlation coefficient.

With reference to the first aspect and the first three implementation manners, in a fourth implementation manner, calculating a corrected frequency-domain energy correlation coefficient according to the frequency-domain energy correlation coefficient and a result of the normalization processing further includes calculating the corrected frequency-domain energy correlation coefficient according to a formula rₖ′=rₖ+(1−max(rₖ₁)), where rₖ′ is the calculated corrected frequency-domain energy correlation coefficient, rₖ is the frequency-domain energy correlation coefficient, rₖ₁ is a frequency-domain energy correlation coefficient of a local maximum point of each group after the grouping, and max(rₖ₁) is a maximum frequency-domain energy correlation coefficient of the local maximum point of each group after the grouping.

With reference to the first aspect and the first four implementation manners, in a fifth implementation manner, segmenting the original speech signal according to the frequency-domain energy correlation coefficient further includes determining a local minimum point of the frequency-domain energy correlation coefficient, and segmenting the speech signal using the local minimum point as a segmentation point when the local minimum point is less than or equal to a set threshold.

With reference to the first aspect and the first five implementation manners, in a sixth implementation manner, after segmenting the original speech signal according to the frequency-domain energy correlation coefficient, the method further includes calculating an average value of time-domain energy within a set time-domain range that uses each segmentation point in the original speech signal as a center, and merging two segments involved by corresponding segmentation points when the calculated corresponding average value within the set time-domain range that uses each segmentation point as the center is less than or equal to a set value.

With reference to the first aspect and the first sixth implementation manners, in a seventh implementation manner, obtaining a first ratio of total energy within any one of the frequency bands of the first speech frame to total energy of the first speech frame according to a real part of the first frequency-domain signal and an imaginary part of the first frequency-domain signal further includes obtaining the first ratio according to

$${ratio}_{—} {energy}_{k} ( f ) = \frac{{\sum }_{i = 0}^{f} ( {Re}_{—} {fft}^{2} ( i ) + {Im}_{—} {fft}^{2} ( i ) )}{{\sum }_{i = 0}^{( {F}_{lim} - 1 )} ( {Re}_{—} {fft}^{2} ( i ) + {Im}_{—} {fft}^{2} ( i ) )} \times 100 \% , f ∈ [ 0 , ( {F}_{lim} - 1 ) ] ,$$

where ratio_energyₖ(f) represents the first ratio of the total energy within any one of the frequency bands of the first speech frame to the total energy of the first speech frame, a value of i is within 0˜f, f represents a quantity of spectral lines, fε[0, (Fₗᵢₘ−1)], (Fₗᵢₘ−1) represents a maximum value of the quantity of the spectral lines of the first speech frame, Re_fft(i) represents the real part of the first frequency-domain signal, Im_fft(i) represents the imaginary part of the first frequency-domain signal,

$${\sum }_{i = 0}^{( {F}_{lim} - 1 )} ( {Re}_{—} {fft}^{2} ( i ) + {Im}_{—} {fft}^{2} ( i ) )$$

represents the total energy of the first speech frame, and

$${\sum }_{i = 0}^{f} ( {Re}_{—} {fft}^{2} ( i ) + {Im}_{—} {fft}^{2} ( i ) )$$

represents total energy within a frequency range 0˜f of the first speech frame.

With reference to the first aspect and the first seven implementation manners, in an eighth implementation manner, performing derivation on the first ratio further includes performing the derivation on the first ratio according to

$${ratio}_{—} {energy}_{k}^{′} ( f ) = {( {\sum }_{n = 0}^{N} ( ( {\prod }_{\begin{matrix}i = 0 \\ i \neq n\end{matrix}}^{N} \frac{f - M - i}{n - i} ) * {ratio}_{—} {energy}_{k} ( n + M ) ) )}^{′} ,$$

where N represents that the foregoing numerical differentiation is N points, and M represents that the derivative value and is obtained using a first ratio within a range fε[M, (M+N−1)].

With reference to the first aspect and the first eight implementation manners, in a ninth implementation manner, obtaining a frequency-domain energy correlation coefficient between the first speech frame and the second speech frame according to the frequency-domain energy distribution of the first speech frame and the frequency-domain energy distribution of the second speech frame further includes calculating the correlation coefficient rₖ according to

$${r}_{k} = \frac{{F}_{lim} \cdot {sum}_{xy} ( k ) - {sum}_{x} ( k - 1 ) \cdot {sum}_{x} ( k )}{\begin{matrix}\sqrt{{F}_{lim} \cdot {sum}_{xx} ( k - 1 ) - {( {sum}_{x} ( k - 1 ) )}^{2}} \cdot \\ \sqrt{{F}_{lim} \cdot {sum}_{xx} ( k ) - {( {sum}_{x} ( k ) )}^{2}}\end{matrix}} , k \geq 1 ,$$

where

$${sum}_{x} ( i ) = {\sum }_{f = 0}^{( {F}_{lim} - 1 )} {ratio}_{—} {energy}_{i}^{′} ( f ) , {sum}_{xx} ( i ) = {\sum }_{f = 0}^{( {F}_{lim} - 1 )} {ratio}_{—} {{energy}_{i}^{′} ( f )}^{2} ,$$

and

$${sum}_{xy} ( i ) = {\sum }_{f = 0}^{( {F}_{lim} - 1 )} [ {ratio}_{—} {energy}_{i - 1}^{′} ( f ) \cdot {ratio}_{—} {energy}_{i}^{′} ( f ) ] ,$$

where k−1 is the first speech frame, k is the second speech frame, and k is greater than or equal to 1.

According to a second aspect, the present disclosure provides an apparatus for processing a speech signal according to frequency-domain energy, including a receiving module configured to receive an original speech signal, where the original speech signal includes a first speech frame and a second speech frame that are adjacent to each other, a transformation module configured to perform a Fourier transform on the first speech frame to obtain a first frequency-domain signal, and perform a Fourier transform on the second speech frame to obtain a second frequency-domain signal, an energy distribution module configured to obtain a frequency-domain energy distribution of the first speech frame according to the first frequency-domain signal, and obtain a frequency-domain energy distribution of the second speech frame according to the second frequency-domain signal, where the frequency-domain energy distribution represents an energy distribution characteristic of the speech frame in a frequency domain, a correlation module configured to obtain a frequency-domain energy correlation coefficient between the first speech frame and the second speech frame according to the frequency-domain energy distribution of the first speech frame and the frequency-domain energy distribution of the second speech frame, where the frequency-domain energy correlation coefficient is used to represent a spectral change from the first speech frame to the second speech frame, and a segmentation module configured to segment the original speech signal according to the frequency-domain energy correlation coefficient.

With reference to the second aspect, in a first implementation manner, a frequency range of the first speech frame includes at least two frequency bands, where the energy distribution module is further configured to obtain a first ratio of total energy within any one of the frequency bands of the first speech frame to total energy of the first speech frame according to a real part of the first frequency-domain signal and an imaginary part of the first frequency-domain signal, and perform derivation on the first ratio to obtain a first derivative that represents the frequency-domain energy distribution of the first speech frame.

With reference to the second aspect and the first implementation manner, in a second implementation manner, the correlation module is further configured to determine the frequency-domain energy correlation coefficient between the first speech frame and the second speech frame according to the first derivative within the frequency range of the first speech frame, a second derivative, and a product of the first derivative and the second derivative, where the second derivative represents the frequency-domain energy distribution of the second speech frame.

With reference to the second aspect and the first two implementation manners, in a third implementation manner, the correlation module is further configured to determine a local maximum point of the frequency-domain energy correlation coefficient, group the original speech signal using the local maximum point as a grouping point, and perform normalization processing on each group obtained by grouping, and calculate a corrected frequency-domain energy correlation coefficient according to the frequency-domain energy correlation coefficient and a result of the normalization processing, and correspondingly, the segmentation module is configured to segment the original speech signal according to the corrected frequency-domain energy correlation coefficient.

With reference to the second aspect and the first three implementation manners, in a fourth implementation manner, the correlation module is further configured to calculate the corrected frequency-domain energy correlation coefficient according to a formula rₖ′=rₖ+(1−max(rₖ₁)), where rₖ′ is the calculated corrected frequency-domain energy correlation coefficient, rₖ is the frequency-domain energy correlation coefficient, rₖ₁ is a frequency-domain energy correlation coefficient of a local maximum point of each group after the grouping, and max(rₖ₁) is a maximum frequency-domain energy correlation coefficient of the local maximum point of each group after the grouping.

With reference to the second aspect and the first four implementation manners, in a fifth implementation manner, the segmentation module is further configured to determine a local minimum point of the frequency-domain energy correlation coefficient, and segment the speech signal using the local minimum point as a segmentation point when the local minimum point is less than or equal to a set threshold.

With reference to the second aspect and the first five implementation manners, in a sixth implementation manner, the segmentation module is further configured to calculate an average value of time-domain energy within a set time-domain range that uses each segmentation point in the original speech signal as a center, and merge two segments involved by corresponding segmentation points when the calculated corresponding average value within the set time-domain range that uses each segmentation point as the center is less than or equal to a set value.

With reference to the second aspect and the first sixth implementation manners, in a seventh implementation manner, the energy distribution module is further configured to obtain the first ratio according to

$${ratio}_{—} {energy}_{k} ( f ) = \frac{{\sum }_{i = 0}^{f} ( {Re}_{—} {fft}^{2} ( i ) + {Im}_{—} {fft}^{2} ( i ) )}{{\sum }_{i = 0}^{( {F}_{lim} - 1 )} ( {Re}_{—} {fft}^{2} ( i ) + {Im}_{—} {fft}^{2} ( i ) )} \times 100 \% , f ∈ [ 0 , ( {F}_{lim} - 1 ) ] ,$$

where ratio_energyₖ(f) represents the first ratio of the total energy within any one of the frequency bands of the first speech frame to the total energy of the first speech frame, a value of i is within 0˜f, f represents a quantity of spectral lines, fε[0, (Fₗᵢₘ−1)], (Fₗᵢₘ−1) represents a maximum value of the quantity of the spectral lines of the first speech frame, Re_fft(i) represents the real part of the first frequency-domain signal, Im_fft(i) represents the imaginary part of the first frequency-domain signal,

$${\sum }_{i = 0}^{( {F}_{lim} - 1 )} ( {Re}_{—} {fft}^{2} ( i ) + {Im}_{—} {fft}^{2} ( i ) )$$

represents the total energy of the first speech frame, and

$${\sum }_{i = 0}^{f} ( {Re}_{—} {fft}^{2} ( i ) + {Im}_{—} {fft}^{2} ( i ) )$$

represents total energy within a frequency range 0˜f of the first speech frame.

With reference to the second aspect and the first seven implementation manners, in an eighth implementation manner, the energy distribution module is further configured to perform the derivation on the first ratio according to

$${ratio}_{—} {energy}_{k}^{′} ( f ) = {( {\sum }_{n = 0}^{N} ( ( {\prod }_{\begin{matrix}i = 0 \\ i \neq n\end{matrix}}^{N} \frac{f - M - i}{n - i} ) * {ratio}_{—} {energy}_{k} ( n + M ) ) )}^{′} ,$$

where N represents that the foregoing numerical differentiation is N points, and M represents that the derivative value and is obtained using a first ratio within a range fε[M, (M+N−1)].

With reference to the second aspect and the first eight implementation manners, in a ninth implementation manner, the correlation module is further configured to calculate the correlation coefficient rₖ according to

$${r}_{k} = \frac{{F}_{lim} \cdot {sum}_{xy} ( k ) - {sum}_{x} ( k - 1 ) \cdot {sum}_{x} ( k )}{\begin{matrix}\sqrt{{F}_{lim} \cdot {sum}_{xx} ( k - 1 ) - {( {sum}_{x} ( k - 1 ) )}^{2}} \cdot \\ \sqrt{{F}_{lim} \cdot {sum}_{xx} ( k ) - {( {sum}_{x} ( k ) )}^{2}}\end{matrix}} , k \geq 1 ,$$

where

$${sum}_{x} ( i ) = {\sum }_{f = 0}^{( {F}_{lim} - 1 )} {ratio}_{—} {energy}_{i}^{′} ( f ) , {sum}_{xx} ( i ) = {\sum }_{f = 0}^{( {F}_{lim} - 1 )} {ratio}_{—} {{energy}_{i}^{′} ( f )}^{2} ,$$

and

$${sum}_{xy} ( i ) = {\sum }_{f = 0}^{( {F}_{lim} - 1 )} [ {ratio}_{—} {energy}_{i - 1}^{′} ( f ) \cdot {ratio}_{—} {energy}_{i}^{′} ( f ) ] ,$$

where k−1 is the first speech frame, k is the second speech frame, and k is greater than or equal to 1.

According to the method and apparatus for processing a speech signal according to frequency-domain energy provided by the embodiments of the present disclosure, an original speech signal including a first speech frame and a second speech frame that are adjacent to each other is received, then, a Fourier transform is performed on the first speech frame and the second speech frame to obtain a first frequency-domain signal and a second frequency-domain signal. A frequency-domain energy distribution of the first speech frame and a frequency-domain energy distribution of the second speech frame are obtained accordingly, where the frequency-domain energy distribution is used to represent an energy distribution characteristic of the speech frame in a frequency domain, according to the frequency-domain energy distribution of the first speech frame and the frequency-domain energy distribution of the second speech frame, a frequency-domain energy correlation coefficient that is between the first speech frame and the second speech frame and that is used to represent a spectral change from the first speech frame to the second speech frame is obtained, and finally, the original speech signal is segmented according to the frequency-domain energy correlation coefficient. In this way, segmentation is performed using the energy distributions of the speech signal in the frequency domain, thereby improving accuracy in segmenting the speech signal.

### BRIEF DESCRIPTION OF DRAWINGS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

FIG. 1 is a flowchart of a method for processing a speech signal according to frequency-domain energy according to Embodiment 1 of the present disclosure;

FIG. 2 is a flowchart of a method for processing a speech signal according to frequency-domain energy according to Embodiment 2 of the present disclosure;

FIG. 3A and FIG. 3B represent a schematic diagram of an English female voice and white noise sequence according to Embodiment 2 of the present disclosure;

FIG. 4 is a schematic diagram of frequency-domain energy distribution curves of the 68^{th} frame to the 73^{rd} frame of an English female voice and white noise sequence according to Embodiment 2 of the present disclosure;

FIG. 5 is a schematic diagram of derivatives of frequency-domain energy distribution curves of the 68^{th} frame to the 73^{rd} frame of an English female voice and white noise sequence according to Embodiment 2 of the present disclosure;

FIG. 6A, FIG. 6B, and FIG. 6C represent a schematic diagram of correlation coefficients between frames of an English female voice and white noise sequence according to Embodiment 2 of the present disclosure;

FIG. 7A, FIG. 7B, and FIG. 7C represent a schematic diagram of adjusted correlation coefficients between frames of an English female voice and white noise sequence according to Embodiment 2 of the present disclosure;

FIG. 8 is a flowchart of segmenting a speech signal according to a correlation between adjacent frames according to Embodiment 2 of the present disclosure;

FIG. 9A and FIG. 9B represent a schematic diagram of performing speech signal segmentation on a Chinese female voice and pink noise sequence according to Embodiment 3 of the present disclosure;

FIG. 10A and FIG. 10B represent a schematic diagram of applying speech signal segmentation performed on a Chinese female voice and pink noise sequence to speech quality assessment;

FIG. 11A and FIG. 11B represent a schematic diagram of applying speech signal segmentation performed on a Chinese female voice and pink noise sequence to speech recognition;

FIG. 12 is a schematic structural diagram of an apparatus for processing a speech signal according to frequency-domain energy according to Embodiment 4 of the present disclosure; and

FIG. 13 is a schematic structural diagram of an apparatus for processing a speech signal according to frequency-domain energy according to Embodiment 5 of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

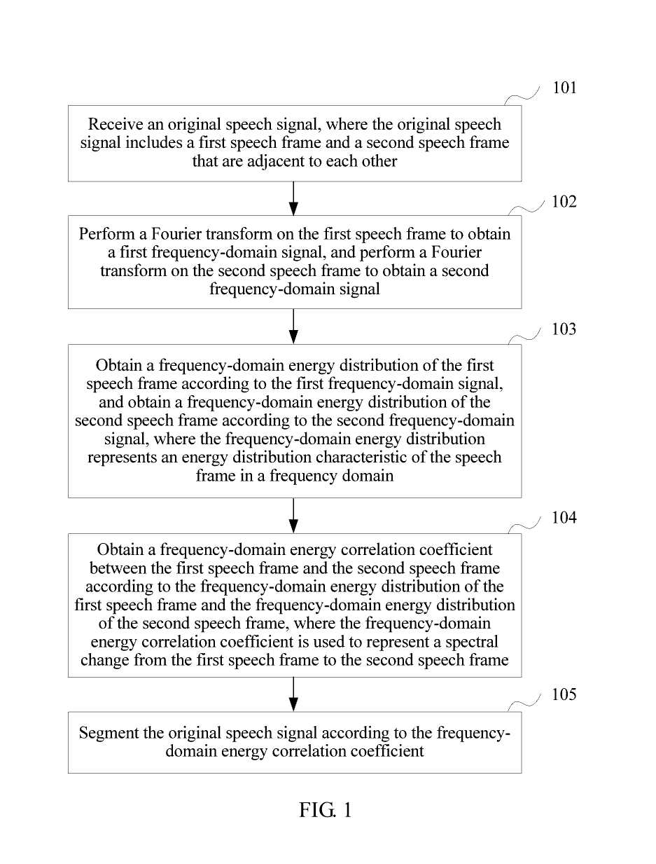

FIG. 1 is a flowchart of a method for processing a speech signal according to frequency-domain energy according to Embodiment 1 of the present disclosure. As shown in FIG. 1, a process of the method for processing a speech signal according to frequency-domain energy provided by this embodiment includes the following steps.

Step 101: Receive an original speech signal, where the original speech signal includes a first speech frame and a second speech frame that are adjacent to each other.

After being received, the original speech signal is converted into a continuous speech frame format for ease of subsequent processing. Therefore, when the original speech signal is processed, descriptions may be provided using any two adjacent speech frames as an example, and a process of processing all speech frames of the speech signal is similar to a process of processing the two adjacent speech frames of the speech signal. For convenience, the adjacent speech frames are defined as the first speech frame and the second speech frame.

Step 102: Perform a Fourier transform on the first speech frame to obtain a first frequency-domain signal, and perform a Fourier transform on the second speech frame to obtain a second frequency-domain signal.

A fast Fourier transformation (FFT) may be performed on current frame data, to convert a time-domain signal into a frequency-domain signal. After the Fourier transform is performed on the first speech frame, the first frequency-domain signal is obtained, and after the Fourier transform is performed on the second speech frame, the second frequency-domain signal is obtained.

Step 103: Obtain a frequency-domain energy distribution of the first speech frame according to the first frequency-domain signal, and obtain a frequency-domain energy distribution of the second speech frame according to the second frequency-domain signal, where the frequency-domain energy distribution represents an energy distribution characteristic of the speech frame in a frequency domain.

Further, obtaining a frequency-domain energy distribution of the first speech frame according to the first frequency-domain signal includes with at least two frequency bands included in a frequency range of the first speech frame, obtaining a first ratio of total energy within any one of the frequency bands of the first speech frame to total energy of the first speech frame according to a real part of the first frequency-domain signal and an imaginary part of the first frequency-domain signal, and performing derivation on the first ratio to obtain a first derivative that represents the frequency-domain energy distribution of the first speech frame.

Obtaining a first ratio of total energy within any one of the frequency bands of the first speech frame to total energy of the first speech frame according to a real part of the first frequency-domain signal and an imaginary part of the first frequency-domain signal further includes obtaining the first ratio according to

$${ratio}_{—} {energy}_{k} ( f ) = \frac{{\sum }_{i = 0}^{f} ( {Re}_{—} {fft}^{2} ( i ) + {Im}_{—} {fft}^{2} ( i ) )}{{\sum }_{i = 0}^{( {F}_{lim} - 1 )} ( {Re}_{—} {fft}^{2} ( i ) + {Im}_{—} {fft}^{2} ( i ) )} \times 100 \% , f ∈ [ 0 , ( {F}_{lim} - 1 ) ] ,$$

where ratio_energyₖ(f) represents the first ratio of the total energy within any one of the frequency bands of the first speech frame to the total energy of the first speech frame, a value of i is within 0˜f, f represents a quantity of spectral lines, fε[0, (Fₗᵢₘ−1)], (Fₗᵢₘ−1) represents a maximum value of the quantity of the spectral lines of the first speech frame, Re_fft(i) represents the real part of the first frequency-domain signal, Im_fft(i) represents the imaginary part of the first frequency-domain signal,

$${\sum }_{i = 0}^{( {F}_{lim} - 1 )} ( {Re}_{—} {fft}^{2} ( i ) + {Im}_{—} {fft}^{2} ( i ) )$$

represents the total energy of the first speech frame, and

$${\sum }_{i = 0}^{f} ( {Re}_{—} {fft}^{2} ( i ) + {Im}_{—} {fft}^{2} ( i ) )$$

represents total energy within a frequency range 0˜f of the first speech frame.

The derivation may be performed using multiple methods, for example, a numerical differentiation algorithm, i.e. an approximation of a derivative or a higher order derivative of a function at a point is calculated according to function values of the function at some discrete points. Generally, numerical differentiation may be performed by means of polynomial interpolation. Methods for the polynomial interpolation include Lagrange interpolation, Newton interpolation, Hermite interpolation, and the like, and are not enumerated one by one herein.

Herein, performing derivation on the first ratio further includes performing the derivation on the first ratio according to

$${ratio}_{—} {energy}_{k}^{′} ( f ) = {( {\sum }_{n = 0}^{N} ( ( {\prod }_{\begin{matrix}i = 0 \\ i \neq n\end{matrix}}^{N} \frac{f - M - i}{n - i} ) * {ratio}_{—} {energy}_{k} ( n + M ) ) )}^{′} ,$$

where N represents that the foregoing numerical differentiation is N points, and M represents that the derivative value and is obtained using a first ratio within a range fε[M, (M+N−1)].

Step 104: Obtain a frequency-domain energy correlation coefficient between the first speech frame and the second speech frame according to the frequency-domain energy distribution of the first speech frame and the frequency-domain energy distribution of the second speech frame, where the frequency-domain energy correlation coefficient is used to represent a spectral change from the first speech frame to the second speech frame.

Further, the frequency-domain energy correlation coefficient between the first speech frame and the second speech frame is determined according to the first derivative within the frequency range of the first speech frame, a second derivative, and a product of the first derivative and the second derivative, where the second derivative represents the frequency-domain energy distribution of the second speech frame.

Further, after obtaining a frequency-domain energy correlation coefficient between the first speech frame and the second speech frame according to the frequency-domain energy distribution of the first speech frame and the frequency-domain energy distribution of the second speech frame, the method further includes determining a local maximum point of the frequency-domain energy correlation coefficient, grouping the original speech signal using the local maximum point as a grouping point, and performing normalization processing on each group obtained by grouping, and calculating a corrected frequency-domain energy correlation coefficient according to the frequency-domain energy correlation coefficient and a result of the normalization processing, and correspondingly, segmenting the original speech signal according to the frequency-domain energy correlation coefficient includes segmenting the original speech signal according to the corrected frequency-domain energy correlation coefficient.

Calculating a corrected frequency-domain energy correlation coefficient according to the frequency-domain energy correlation coefficient and a result of the normalization processing further includes calculating the corrected frequency-domain energy correlation coefficient according to a formula rₖ′=rₖ+(1−max(rₖ₁)), where rₖ′ is the calculated corrected frequency-domain energy correlation coefficient, rₖ is the frequency-domain energy correlation coefficient, rₖ₁ is a frequency-domain energy correlation coefficient of a local maximum point of each group after the grouping, and max(rₖ₁) is a maximum frequency-domain energy correlation coefficient of the local maximum point of each group after the grouping.

The correlation coefficient may also be calculated using multiple methods, for example, a Pearson product-moment correlation coefficient algorithm.

The correlation coefficient can sensitively reflect a spectral change situation of the speech signal. Generally, the correlation coefficient approaches closer to 1 when a spectrum status of a speech signal spectrum is increasingly steady, and the correlation coefficient decreases rapidly within a short time when the speech signal spectrum changes obviously, for example, undergoes a transition from a syllable to another syllable.

Step 105: Segment the original speech signal according to the frequency-domain energy correlation coefficient.

Further, segmenting the original speech signal according to the frequency-domain energy correlation coefficient includes determining a local minimum point of the frequency-domain energy correlation coefficient, and segmenting the speech signal using the local minimum point as a segmentation point when the local minimum point is less than or equal to a set threshold.

It can be learned according to the above-described characteristic of the correlation coefficient that, when a value of the correlation coefficient is less than a threshold, for example the threshold is 0.8, i.e. when the correlation coefficient is less than 0.8, it indicates that a spectral position of the speech signal has changed obviously, segmentation may be performed at a corresponding position, and segmentation does not need to be performed at a position where the correlation coefficient is greater than or equal to 0.8.

After segmenting the original speech signal according to the frequency-domain energy correlation coefficient, the method further includes calculating an average value of time-domain energy within a set time-domain range that uses each segmentation point in the original speech signal as a center, and merging two segments involved by corresponding segmentation points when the calculated corresponding average value within the set time-domain range that uses each segmentation point as the center is less than or equal to a set value.

In this embodiment, an original speech signal including a first speech frame and a second speech frame that are adjacent to each other is received A Fourier transform is performed on the first speech frame and the second speech frame to obtain a first frequency-domain signal and a second frequency-domain signal. A frequency-domain energy distribution of the first speech frame and a frequency-domain energy distribution of the second speech frame are obtained accordingly, where the frequency-domain energy distribution is used to represent an energy distribution characteristic of the speech frame in a frequency domain, a frequency-domain energy correlation coefficient that is between the first speech frame and the second speech frame and that is used to represent a spectral change from the first speech frame to the second speech frame is obtained according to the frequency-domain energy distribution of the first speech frame and the frequency-domain energy distribution of the second speech frame, and finally, the original speech signal is segmented according to the frequency-domain energy correlation coefficient. In this way, the segmentation is performed using the frequency-domain energy distribution of the speech signal, thereby improving accuracy in segmenting the speech signal.

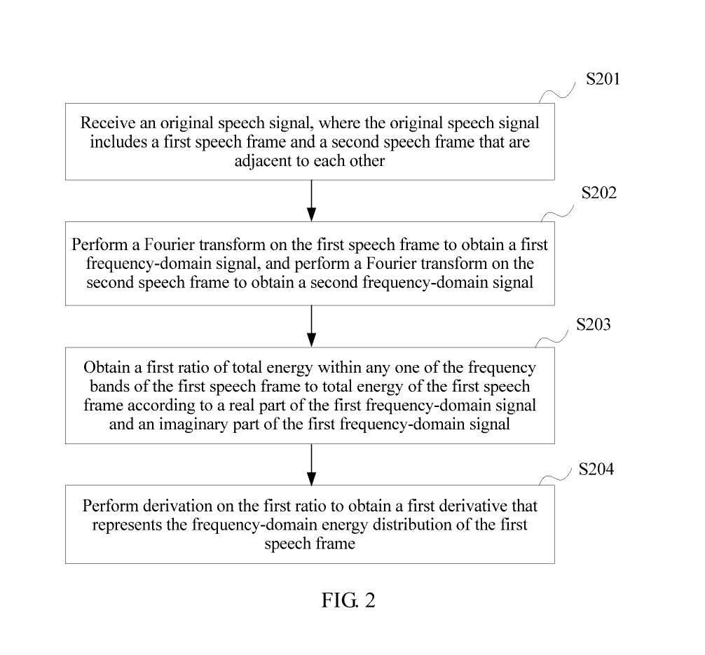

FIG. 2 is a flowchart of a method for processing a speech signal according to frequency-domain energy according to Embodiment 2 of the present disclosure. As shown in FIG. 2, based on the illustration in FIG. 1, this embodiment provides in detail detailed steps in a processing process of segmenting a speech signal according to frequency-domain energy.

Steps of calculating an energy distribution characteristic of a speech frame in a frequency domain further includes the following steps.

Step S201: Receive an original speech signal, where the original speech signal includes a first speech frame and a second speech frame that are adjacent to each other.

After the original speech signal is received, the speech signal may be filtered in step S201. For example, 50 hertz (Hz) high-pass filtering may be performed to remove a direct-current component in the speech signal, to enable the signal to reach a relatively ideal signal status.

After being received, the original speech signal is converted into a continuous speech frame format for ease of subsequent processing. Therefore, descriptions may be provided using any two adjacent speech frames as an example, and a process of processing all speech frames of the speech signal is similar to a process of processing the two adjacent speech frames of the speech signal when the original speech signal is processed. For convenience, the adjacent speech frames are defined as the first speech frame and the second speech frame.

Step S202: Perform a Fourier transform on the first speech frame to obtain a first frequency-domain signal, and perform a Fourier transform on the second speech frame to obtain a second frequency-domain signal.

Further, because the current speech signal is a time-domain signal, an FFT transform may be performed on the speech signal, to convert the speech signal into a frequency-domain signal. A Fourier transform, for example an FFT, may be performed on current frame data of the speech signal by setting a sampling rate of the speech signal to 8 kilohertz (KHz), where a size F of the FFT may be 1024. In this way, after the Fourier transform is performed on the first speech frame and the second speech frame, the first frequency-domain signal and the second frequency-domain signal may be obtained.

Step S203: Obtain a first ratio of total energy within any one of the frequency bands of the first speech frame to total energy of the first speech frame according to a real part of the first frequency-domain signal and an imaginary part of the first frequency-domain signal.

A frequency range of the first speech frame includes at least two frequency bands. Calculation may be performed according to a quantity of spectral lines within any one of the frequency bands when the total energy within any one of the frequency bands of the first speech frame is calculated, where the quantity of the spectral lines is related to the size F of the FFT.

It can be understood that, a value of the quantity of spectral lines may also be assigned in another manner capable of being implemented by persons of ordinary skill in the art, and the foregoing example is only an example intended to help understand this embodiment of the present disclosure, and shall not be construed as a limitation to this embodiment of the present disclosure.

Obtaining a first ratio of total energy of the first speech frame within a frequency range 0˜f to the total energy of the first speech frame according to the real part of the first frequency-domain signal and the imaginary part of the first frequency-domain signal further includes obtaining the first ratio according to

$${ratio}_{—} {energy}_{k} ( f ) = \frac{{\sum }_{i = 0}^{f} ( {Re}_{—} {fft}^{2} ( i ) + {Im}_{—} {fft}^{2} ( i ) )}{{\sum }_{i = 0}^{( {F}_{lim} - 1 )} ( {Re}_{—} {fft}^{2} ( i ) + {Im}_{—} {fft}^{2} ( i ) )} \times 100 \% , f ∈ [ 0 , ( {F}_{lim} - 1 ) ] ,$$

where ratio_energyₖ(f) represents the first ratio of the total energy within any one of the frequency bands of the first speech frame to the total energy of the first speech frame, a value of i is within 0˜f, f represents a quantity of spectral lines, fε[0, (Fₗᵢₘ−1)], (Fₗᵢₘ−1) represents a maximum value of the quantity of the spectral lines of the first speech frame, Re_fft(i) represents the real part of the first frequency-domain signal, Im_fft(i) represents the imaginary part of the first frequency-domain signal,

$${\sum }_{i = 0}^{( {F}_{lim} - 1 )} ( {Re}_{—} {fft}^{2} ( i ) + {Im}_{—} {fft}^{2} ( i ) )$$

represents the total energy of the first speech frame, and

$${\sum }_{i = 0}^{f} ( {Re}_{—} {fft}^{2} ( i ) + {Im}_{—} {fft}^{2} ( i ) )$$

represents total energy within a frequency range 0˜f of the first speech frame.

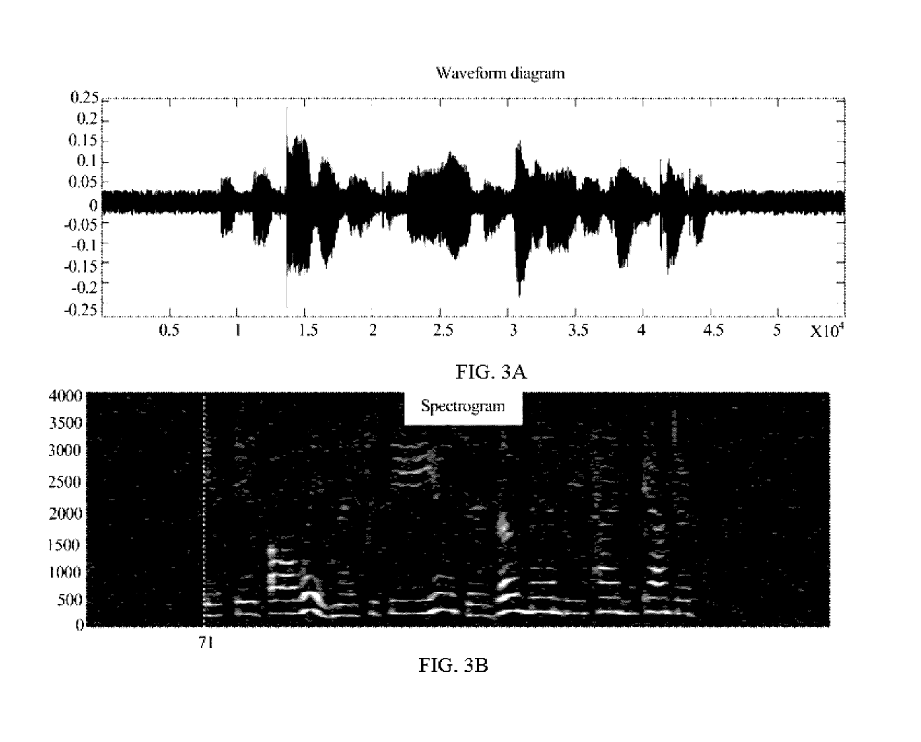

Further, descriptions may be provided using an example of an English female voice and white noise sequence shown in FIG. 3A and FIG. 3B. In FIG. 3A is a waveform diagram, a horizontal axis represents sample points, and a vertical axis represents normalized amplitude. FIG. 3B is a spectrogram, a horizontal axis represents frame numbers, and in a time domain, the frame numbers are corresponding to the sample points in FIG. 3A, a vertical axis represents frequency. The 71^{st} frame marked by a thin white dotted line in FIG. 3B is a start frame of a speech signal.

The following can be seen from FIG. 3A and FIG. 3B.

(1) There is no tonal component in a white noise portion, before the speech signal, in the spectrogram, and energy is evenly distributed in an entire bandwidth range.

(2) In a start portion of the speech signal in the spectrogram, there are two obvious tonal components from 0 to 500 Hz (including 0 Hz and 500 Hz). Energy is no longer evenly distributed in the entire bandwidth range, and instead, the energy is concentrated in two frequency bands in which the tonal components are located.

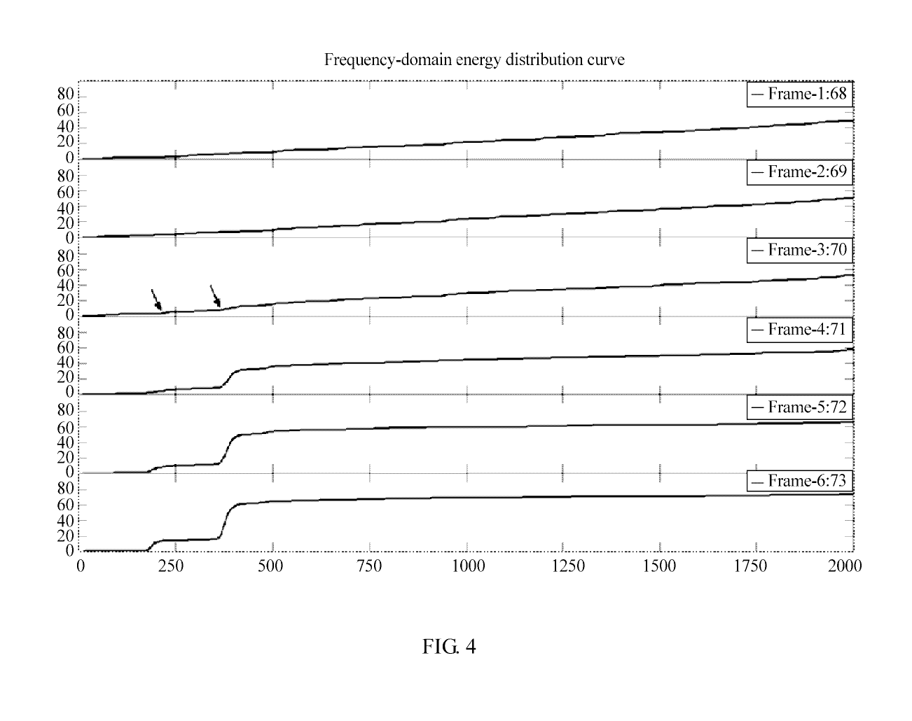

For the sequence given in FIG. 3A and FIG. 3B, six sub-diagrams of FIG. 4 from top to bottom provide frequency-domain energy distributions of the 68^{th} frame to the 73^{rd} frame respectively. A horizontal axis of each sub-diagram represents frequency. For ease of display, only frequency-domain energy distributions from 0 to 2000 Hz (including 0 Hz and 2000 Hz) are displayed. A vertical axis of each sub-diagram represents a percentage value ranging from 0 to 100% (including 0 and 100%). A frequency-domain energy distribution of a specific frame has an arrow for indicating a portion at which the frequency-domain energy distribution changes.

The following can be seen from FIG. 4:

(1) The 68^{th} frame and the 69^{th} frame are a white noise segment. A curve that represents the frequency-domain energy distribution is substantially a straight line when the energy is evenly distributed in the entire bandwidth range.

(2) The 70^{th} frame is a transition segment between white noise and the speech signal. Compared with that in the preceding two frames, the curve representing the frequency-domain energy distribution in the 70^{th} frame fluctuates slightly at positions indicated by two arrows, which indicates that a frequency-domain energy distribution situation of the current frame starts changing.

(3) The 71^{st} frame to the 73^{rd} frame are a speech segment, and there are two obvious tonal components in a frequency range of 0 to 500 Hz (including 0 Hz and 500 Hz). The curve that represents the frequency-domain energy distribution is no longer a straight line, instead, there are increasingly obvious fluctuations in the frequency bands in which the tonal components are located.

It can be seen from FIG. 3A, FIG. 3B and FIG. 4 that, when the speech signal changes, the frequency-domain energy distribution of the speech signal changes at the same time, the curve that represents the frequency-domain energy distribution of the speech signal fluctuates in the frequency bands in which the tonal components of the speech signal are located, and therefore, a change of the frequency-domain energy distribution can faithfully reflect a change situation of the speech signal. Therefore, a change situation of the speech signal can be obtained according to a change situation of the frequency-domain energy distributions of the first speech frame and the second speech frame that are adjacent to each other.

The change situation of the speech signal may be obtained by analyzing a correlation between adjacent frames in the speech signal, and a change situation of the frequency-domain energy distribution can be inferred by calculating an energy distribution characteristic when analyzing a frequency-domain energy distribution, which changes with the frequency, of each frame.

Step S204: Perform derivation on the first ratio to obtain a first derivative that represents the frequency-domain energy distribution of the first speech frame.

The performing derivation on the first ratio further includes performing the derivation on the first ratio according to

$${ratio}_{—} {energy}_{k}^{′} ( f ) = {( {\sum }_{n = 0}^{N} ( ( {\prod }_{\begin{matrix}i = 0 \\ i \neq n\end{matrix}}^{N} \frac{f - M - i}{n - i} ) * {ratio}_{—} {energy}_{k} ( n + M ) ) )}^{′} ,$$

where N represents that the foregoing numerical differentiation is N points, and M represents that the derivative value and is obtained using a first ratio within a range fε[M, (M+N−1)].

Derivation may be performed on the ratio of the total energy within any one of the frequency bands of the first speech frame to the total energy of the first speech frame and on a ratio of total energy within any one of frequency ranges of the second speech frame to total energy of the second speech frame, to obtain the energy distribution characteristic, which changes with the frequency, of each frame. Derivatives of the ratios may be calculated using multiple methods such as a numerical differentiation method. Further, specific calculation may be performed by means of Lagrange interpolation when the derivatives of the first ratio and the second ratio are calculated using the numerical differentiation method.

When a Lagrange seven-point numerical differentiation formula is used,

$${ratio}_{—} {energy}_{k}^{′} ( f ) = - \frac{1}{60} {ratio}_{—} {energy}_{k} ( f - 3 ) + \frac{9}{60} {ratio}_{—} {energy}_{k} ( f - 2 ) - \frac{45}{60} {ratio}_{—} {energy}_{k} ( f - 1 ) , f ∈ [ 3 , ( F \text{/} 2 - 4 ) ]$$

is

$$+ \frac{45}{60} {ratio}_{—} {energy}_{k} ( f + 1 ) - \frac{9}{60} {ratio}_{—} {energy}_{k} ( f + 2 ) + \frac{1}{60} {ratio}_{—} {energy}_{k} ( f + 3 )$$

used to perform derivation on the ratios, and, ratio_energyₖ′(f) is set to 0 when fε[0, 2] or fε[(F/2−3), (F/2−1)].

In addition, a Lagrange three-point numerical differentiation formula, a Lagrange five-point numerical differentiation formula, and the like may be used to calculate the derivatives of the ratios. When the Lagrange three-point numerical differentiation formula is used,

$${ratio}_{—} {energy}_{k}^{′} ( f ) = - \frac{1}{2} {ratio}_{—} {energy}_{k} ( f - 1 ) + \frac{1}{2} {ratio}_{—} {energy}_{k} ( f + 1 ) , f ∈ [ 1 , ( F \text{/} 2 - 2 ) ]$$

is used to perform the derivation on the ratios, and ratio_energyₖ′(f) is set to 0 when f=0 or f=(F/2−1).

When the Lagrange five-point numerical differentiation formula is used,

$${ratio}_{—} {energy}_{k}^{′} ( f ) = \frac{1}{12} {ratio}_{—} {energy}_{k} ( f - 2 ) - \frac{8}{12} {ratio}_{—} {energy}_{k} ( f - 1 ) , f ∈ [ 2 , ( F \text{/} 2 - 3 ) ]$$

is

$$+ \frac{8}{12} {ratio}_{—} {energy}_{k} ( f + 1 ) - \frac{1}{12} {ratio}_{—} {energy}_{k} ( f + 2 )$$

used to perform the derivation on the ratios, and ratio_energyₖ′(f) is set to 0 when fε[0, 1] or fε[(F/2−2), (F/2−1)].

In addition, methods such as Newton interpolation and Hermite interpolation may also be used to perform the derivation on the ratios, and details are not described herein.

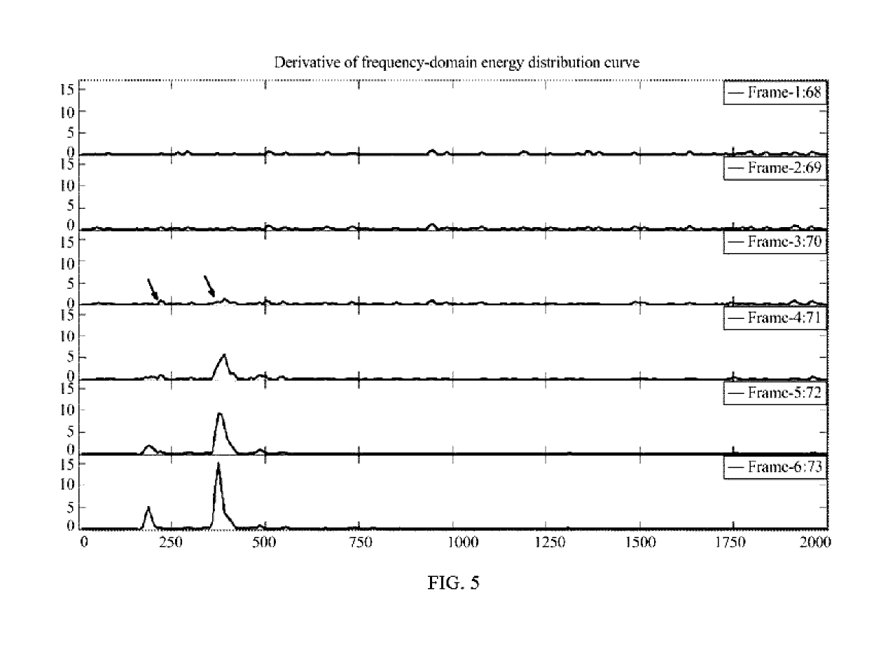

The English female voice and white noise sequence are still used as an example. Six sub-diagrams of FIG. 5 from top to bottom provide derivatives of ratios of frequency-domain energy distributions of the 68^{th} frame to the 73^{rd} frame respectively. A horizontal axis represents frequency, and a vertical axis represents derivative values.

The following can be seen from FIG. 5:

(1) The 68^{th} frame and the 69^{th} frame are a white noise segment. Energy is substantially evenly distributed in an entire bandwidth range, and derivatives of the ratios of the frequency-domain energy distributions are substantially 0.

(2) The 70^{th} frame is a transition segment between white noise and the speech signal. Compared with that in the preceding two frames, derivative values of the ratios of the frequency-domain energy distributions undergo two relatively small changes at positions indicated by two arrows, which indicates that a frequency-domain energy distribution situation of the current frame starts changing.

(3) The 71^{st} frame to the 73^{rd} frame are a speech segment, and there are two obvious tonal components in a frequency range of 0 to 500 Hz (including 0 Hz and 500 Hz). The derivatives of the ratios of the frequency-domain energy distributions have two peaks at frequencies corresponding to the two tonal components.

It can be seen from FIG. 5 that, when the speech signal changes, derivative values of the ratios of the frequency-domain energy distributions of the speech signal change within frequency bands in which the tonal components of the speech signal are located, and therefore the energy distribution characteristic, which changes with the frequency, of each frame can be obtained by performing derivation on the ratios.

The correlation between adjacent frames may be determined according to the energy distribution characteristic, which changes with the frequency, of each frame, for example, a correlation coefficient between adjacent frames may be calculated according to a derivation result. For example, a frequency-domain energy correlation coefficient between the first speech frame and the second speech frame may be obtained according to the frequency-domain energy distribution of the first speech frame and the frequency-domain energy distribution of the second speech frame. Furthermore, the frequency-domain energy correlation coefficient between the first speech frame and the second speech frame may be determined according to the first derivative within the frequency range of the first speech frame, a second derivative, and a product of the first derivative and the second derivative, where the second derivative represents the frequency-domain energy distribution of the second speech frame.

The correlation coefficient may be calculated using multiple methods. In the following example, the correlation coefficient is calculated using a Pearson product-moment correlation coefficient algorithm. It is assumed that the current frame is the k^{th} frame, and a specific formula for calculating the correlation coefficient rₖ is

$${r}_{k} = \frac{\frac{F}{2} \cdot {sum}_{xy} ( k ) - {sum}_{x} ( k - 1 ) \cdot {sum}_{x} ( k )}{\begin{matrix}\sqrt{\frac{F}{2} \cdot {sum}_{xx} ( k - 1 ) - {( {sum}_{x} ( k - 1 ) )}^{2}} \cdot \\ \sqrt{\frac{F}{2} \cdot {sum}_{xx} ( k ) - {( {sum}_{x} ( k ) )}^{2}}\end{matrix}} , k \geq 1$$

in the formula, F is the size of the

$$FFT , {sum}_{x} ( i ) = {\sum }_{f = 0}^{( F \text{/} 2 - 1 )} {ratio}_{—} {energy}_{i}^{′} ( f ) , {sum}_{xx} ( i ) = {\sum }_{f = 0}^{( F \text{/} 2 - 1 )} {ratio}_{—} {{energy}_{i}^{′} ( f )}^{2} ,$$

and

$${sum}_{xy} ( i ) = {\sum }_{f = 0}^{( F \text{/} 2 - 1 )} [ {ratio}_{—} {energy}_{i - 1}^{′} ( f ) \cdot {ratio}_{—} {energy}_{i}^{′} ( f ) ] .$$

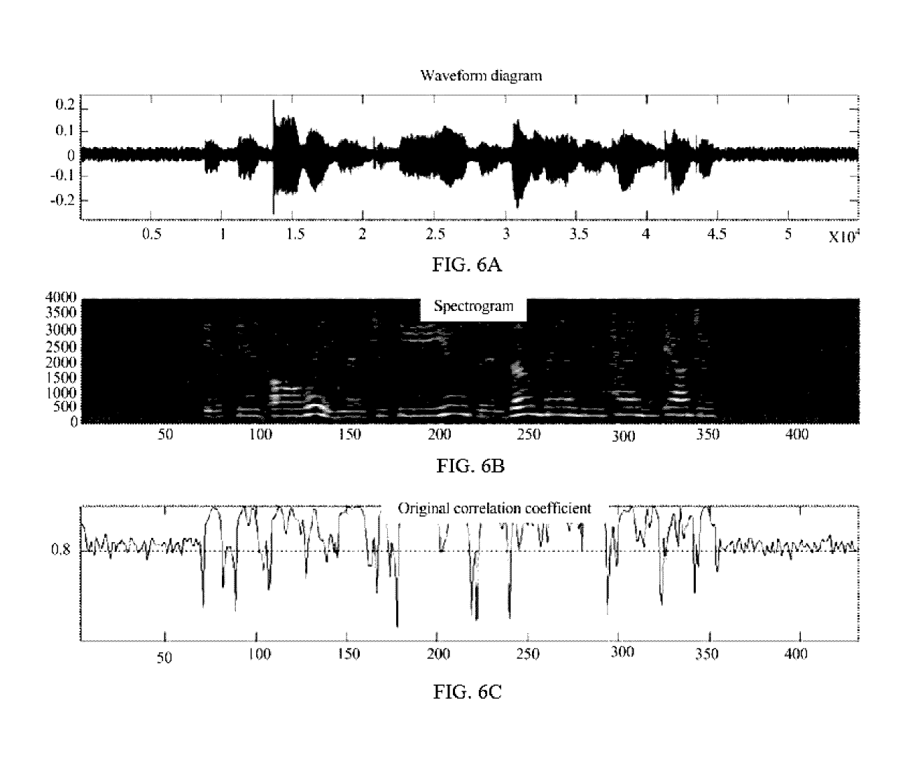

Descriptions are provided by still using the English female voice and white noise sequence as an example. FIG. 6A, FIG. 6B, and FIG. 6C represent a schematic diagram of correlation coefficients between frames of the English female voice and white noise sequence, where FIG. 6A is a waveform diagram, FIG. 6B is a spectrogram, and FIG. 6C is a correlation coefficient. A horizontal axis represents frame numbers, a vertical axis represents correlation coefficients, and a dotted line is set as a baseline at a horizontal axis with a value of the correlation coefficient being 0.8.

The following can be seen from FIG. 6A, FIG. 6B, and FIG. 6C.

(1) There is no tonal component in a white noise portion, before the speech signal, in the spectrogram, energy is evenly distributed in an entire bandwidth range, and in this case, the correlation coefficient is a curve that fluctuates within a small range at the dotted line of 0.8.

(2) In a start portion of the speech signal in the spectrogram, there are two obvious tonal components from 0 to 500 Hz (including 0 Hz and 500 Hz). In this case, the correlation coefficient fluctuates violently at corresponding tonal components, falls dramatically to be below the dotted line of 0.8 at the beginning of a tonal component, and rises rapidly to be close to 1 at the tonal component, falls dramatically again to be below the dotted line of 0.8 at the end of the tonal component, and restores rapidly again to be above the dotted line of 0.8.

It can be seen from FIG. 6A, FIG. 6B, and FIG. 6C that, the correlation coefficient can sensitively reflect a spectral change situation of the signal. Generally, the correlation coefficient approaches 1 when a spectrum status in the spectrogram is increasingly steady, and the correlation coefficient decreases rapidly within a short time when a spectrum in the spectrogram changes obviously, for example, undergoes a transition from a syllable to another syllable. It indicates that a signal spectrum has changed obviously when the value of the correlation coefficient is less than a set threshold (for example, 0.8), and segmentation needs to be performed herein. Otherwise, segmentation does not need to be performed.

Optionally, after the correlation coefficient between adjacent frames in the speech signal is calculated according to the derivation result, because a white noise portion in the spectrogram is different from the speech signal in the spectrogram, change of the spectrum status is always kept in a state between “steady” and “obvious change”, the correlation coefficient of the spectrum of the white noise portion always fluctuates within a relatively narrow range. In this case, several inaccurate segmentation results will be obtained from the white noise portion when a value within this range is used as a threshold to perform segmentation. Therefore, the initially calculated correlation coefficient may be adjusted, to ensure the speech signal is segmented and white noise portions before and after the speech signal are not segmented. Adjustment may further include determining a local maximum point of the correlation coefficient, grouping the speech signal using the local maximum point as a grouping point, and performing normalization processing on each group obtained by grouping, and calculating a corrected frequency-domain energy correlation coefficient according to the frequency-domain energy correlation coefficient and a result of the normalization processing, which further includes calculating the corrected frequency-domain energy correlation coefficient according to a formula rₖ′=rₖ+(1−max(rₖ₁)), where rₖ′ is the calculated corrected frequency-domain energy correlation coefficient, rₖ is the correlation coefficient, rₖ₁ is a correlation coefficient of a local maximum point of each group after the grouping, and max(rₖ₁) is a maximum correlation coefficient of the local maximum point of each group after the grouping. Correspondingly, segmenting the original speech signal according to the frequency-domain energy correlation coefficient includes segmenting the original speech signal according to the corrected frequency-domain energy correlation coefficient.

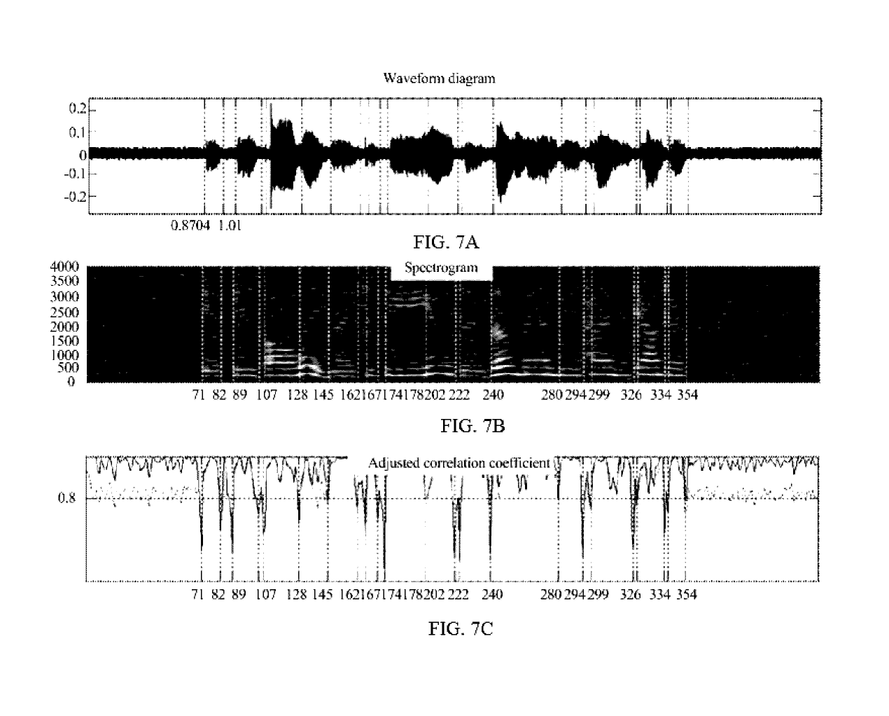

FIG. 7A, FIG. 7B, and FIG. 7C represent a schematic diagram of adjusted correlation coefficients between frames of the English female voice and white noise sequence, where FIG. 7A is a waveform diagram, FIG. 7B is a spectrogram, and in FIG. 7C a dotted line represents original correlation coefficients, and a solid line represents adjusted correlation coefficients. It can be seen from the figure that, adjustment is mainly for noise portions, and has little impact on a speech portion. For the adjusted correlation coefficients, segmentation is performed using 0.8 as a threshold, and therefore, the speech signal can be accurately segmented, and the white noise portions before and after the speech signal are not segmented incorrectly.

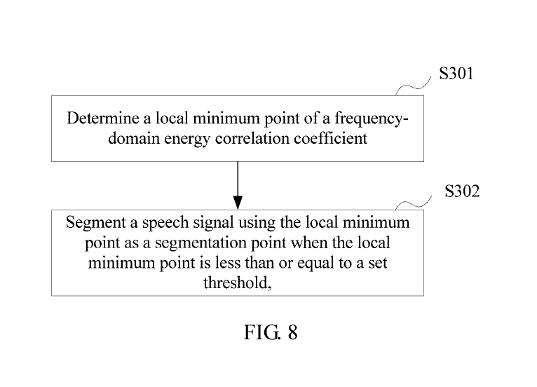

Further, after a correlation between adjacent frames is obtained, the speech signal is segmented according to the correlation between adjacent frames. As shown in FIG. 8, the step of segmenting the original speech signal according to the frequency-domain energy correlation coefficient further includes the following steps.

Step S301: Determine a local minimum point of the frequency-domain energy correlation coefficient.

Step S302: Segment the speech signal using the local minimum point as a segmentation point when the local minimum point is less than or equal to a set threshold.

Further, the set threshold for segmentation may be set according to a specific use requirement. Refined segmentation needs to be performed on the speech signal, and the set threshold may be set relatively large when the segmentation is a phoneme division algorithm for speech recognition, and segmentation on the speech signal is relatively rough, and the set threshold may be set relatively small when the segmentation is a speech segmentation algorithm for speech quality assessment.

Further, after segmenting the speech signal using the local minimum point as a segmentation point, further, segmentation results may be merged, which may further include calculating an average value of time-domain energy within a set time-domain range that uses each segmentation point in the original speech signal as a center, and merging two segments involved by corresponding segmentation points when the calculated corresponding average value within the set time-domain range that uses each segmentation point as the center is less than or equal to a set value.

Speech signal segmentation is applicable to multiple application scenarios including speech quality assessment, speech recognition, and the like.

The speech signal segmentation method in this embodiment of the present disclosure may be combined with an existing voiced sound and noise classification algorithm to implement a segmentation algorithm for speech quality assessment when performing speech quality assessment.

In this embodiment, calculating an energy distribution characteristic of a speech frame in a frequency domain further includes receiving an original speech signal including a first speech frame and a second speech frame that are adjacent to each other, performing a Fourier transform on the first speech frame and the second speech frame to obtain a first frequency-domain signal and a second frequency-domain signal, obtaining a first ratio of total energy of the first speech frame within a frequency range 0˜f to total energy of the first speech frame according to a real part and an imaginary part of the first frequency-domain signal and obtaining a second ratio of total energy of the second speech frame within the frequency range 0˜f to total energy of the second speech frame according to a real part and an imaginary part of the second frequency-domain signal, and finally performing derivation on the first ratio and the second ratio, to obtain a first derivative and a second derivative that respectively represent a frequency-domain energy distribution of the first speech frame and a frequency-domain energy distribution of the second speech frame. A local minimum point of a correlation coefficient is determined first when segmenting the speech signal according to a correlation between adjacent frames, and the speech signal is segmented using the local minimum point as a segmentation point when the local minimum point is less than or equal to a set threshold. In this way, the speech signal is segmented according to the frequency-domain energy distributions, thereby improving accuracy in segmenting the speech signal.

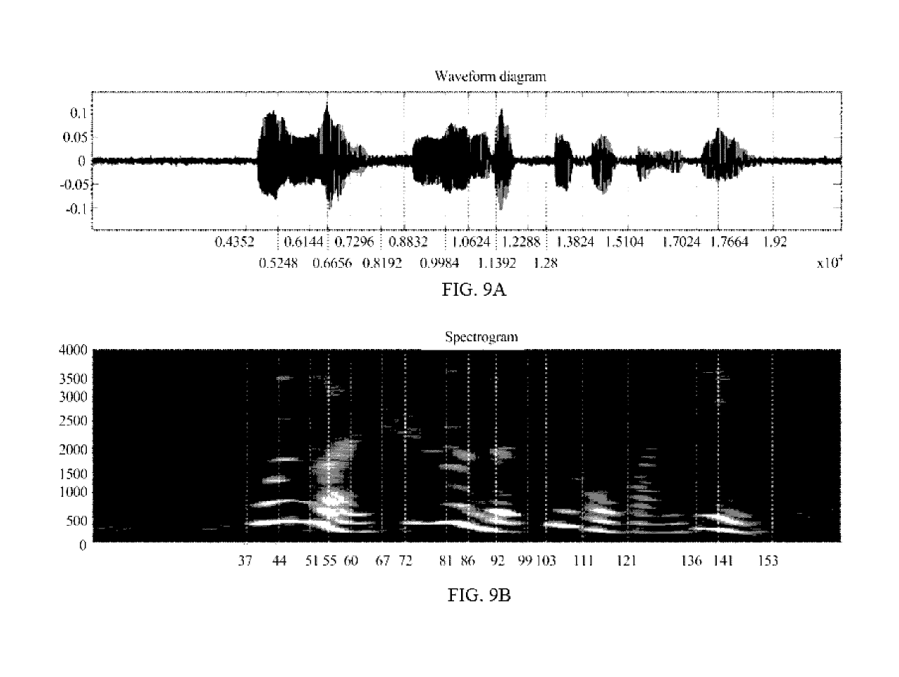

FIG. 9A and FIG. 9B represent a schematic diagram of performing speech signal segmentation on a Chinese female voice and pink noise sequence according to Embodiment 3 of the present disclosure. As shown in FIG. 9A and FIG. 9B, a speech signal segmentation method in this embodiment is similar to that in the foregoing embodiment, and details are not described herein. In addition to the foregoing embodiment, the speech signal segmentation method provided by this embodiment may also be applied to speech quality assessment or speech recognition.

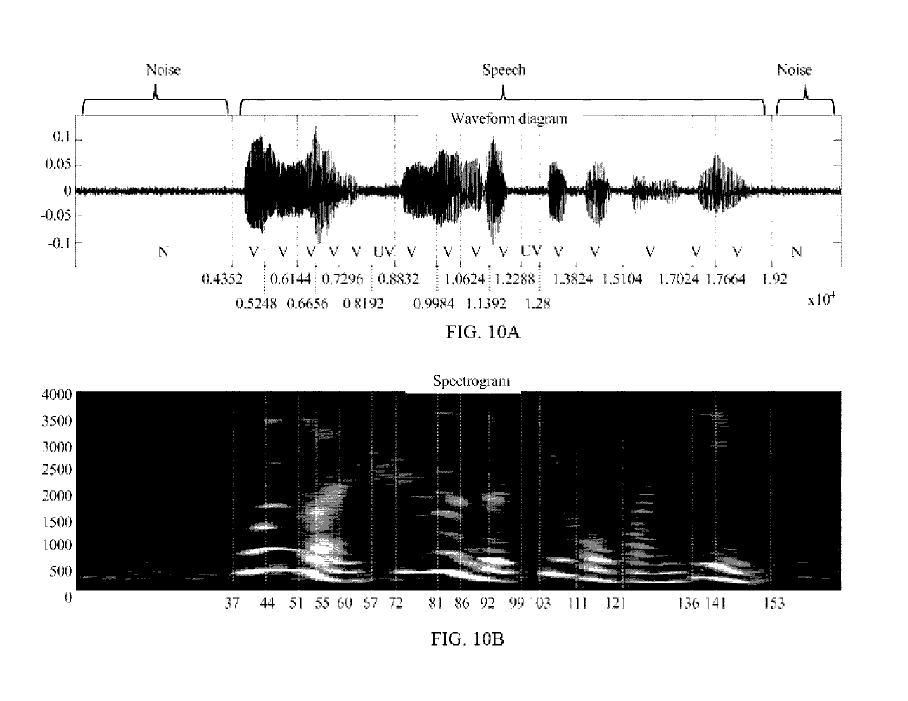

A specific application process of the speech signal segmentation method is shown in FIG. 10A and FIG. 10B when performing speech quality assessment, for example, performing speech quality assessment on the Chinese female voice and pink noise sequence, where V represents a voiced sound, UV represents an unvoiced sound, and N represents noise. In this way, it may be analyzed that each segment in refined segmentation is a voiced sound, an unvoiced sound, or noise, then, an unvoiced sound segment and a voiced sound segment are merged to form a speech segment, and a speech segment and a noise segment for scoring are obtained. Therefore, a to-be-assessed speech signal is divided into relatively long segments, to facilitate subsequent scoring for speech quality assessment.

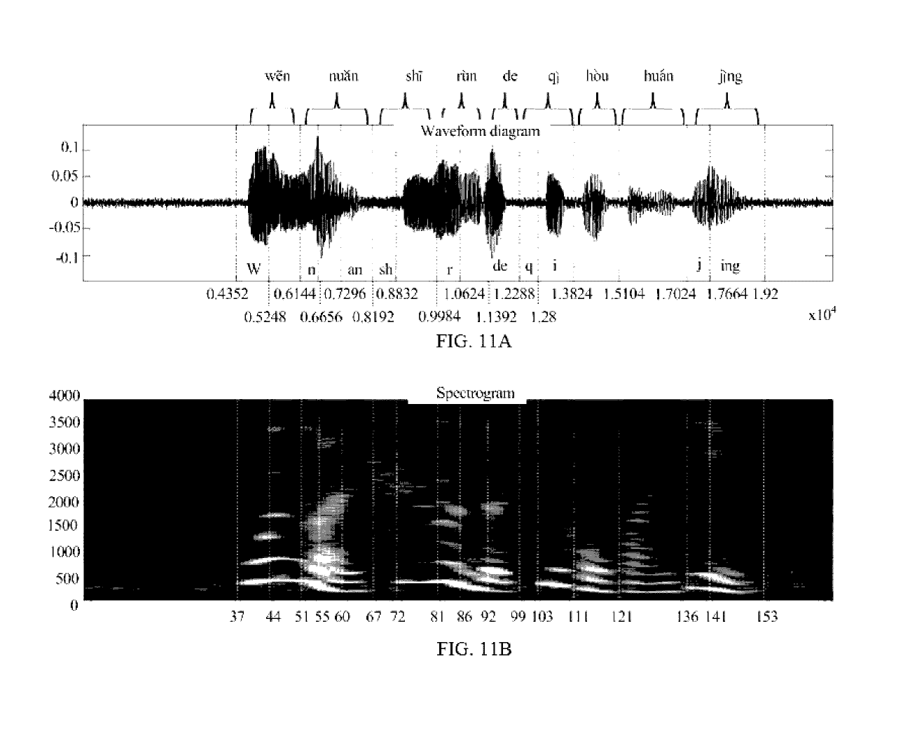

the speech recognition is still performed on the Chinese female voice and pink noise sequence when performing speech recognition, and a specific application process of the speech signal segmentation method is shown in FIG. 11A and FIG. 11B. In this embodiment, refined speech signal segmentation provided by the speech signal segmentation method can be accurate to a phoneme, and may be used to implement an automatic phoneme division algorithm for an initial phase of speech recognition. Finally, a refined speech signal segmentation result accurate to a phoneme or a syllable is obtained. Later, recognition may further be performed on words formed by phonemes or syllables according to the refined segmentation result.

In this embodiment, the speech signal segmentation method may be used to complete refined speech signal segmentation, to perform speech quality assessment. It is analyzed that each segment in the refined segmentation is a voiced sound, an unvoiced sound, or noise, and a speech segment and a noise segment for scoring are obtained, or, the speech signal segmentation method is applied to speech recognition, to obtain a refined speech signal segmentation result accurate to a phoneme or a syllable.

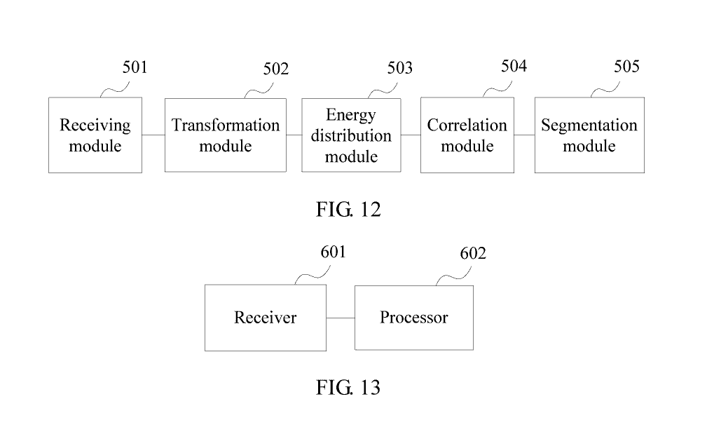

FIG. 12 is a schematic structural diagram of an apparatus for processing a speech signal according to frequency-domain energy according to Embodiment 4 of the present disclosure. As shown in FIG. 12, the apparatus for processing a speech signal according to frequency-domain energy includes a receiving module 501 configured to receive an original speech signal, where the original speech signal includes a first speech frame and a second speech frame that are adjacent to each other, a transformation module 502 configured to perform a Fourier transform on the first speech frame to obtain a first frequency-domain signal, and perform a Fourier transform on the second speech frame to obtain a second frequency-domain signal, an energy distribution module 503 configured to obtain a frequency-domain energy distribution of the first speech frame according to the first frequency-domain signal, and obtain a frequency-domain energy distribution of the second speech frame according to the second frequency-domain signal, where the frequency-domain energy distribution represents an energy distribution characteristic of the speech frame in a frequency domain, a correlation module 504 configured to obtain a frequency-domain energy correlation coefficient between the first speech frame and the second speech frame according to the frequency-domain energy distribution of the first speech frame and the frequency-domain energy distribution of the second speech frame, where the frequency-domain energy correlation coefficient is used to represent a spectral change from the first speech frame to the second speech frame, and a segmentation module 505 configured to segment the original speech signal according to the frequency-domain energy correlation coefficient.

Further, a frequency range of the first speech frame includes at least two frequency bands, and the energy distribution module 503 is configured to obtain a first ratio of total energy within any one of the frequency bands of the first speech frame to total energy of the first speech frame according to a real part of the first frequency-domain signal and an imaginary part of the first frequency-domain signal, and perform derivation on the first ratio to obtain a first derivative that represents the frequency-domain energy distribution of the first speech frame and the frequency-domain energy distribution of the second speech frame.

The energy distribution module 503 is further configured to obtain the first ratio according to

$${ratio\_energy}_{k} ( f ) = \frac{{\sum }_{i = 0}^{f} ( {Re\_fft}^{2} ( i ) + {Im\_fft}^{2} ( i ) )}{{\sum }_{i = 0}^{( {F}_{lim} - 1 )} ( {Re\_fft}^{2} ( i ) + {Im\_fft}^{2} ( i ) )} \times 100 \% , \\ f ∈ [ 0 , ( {F}_{lim} - 1 ) ] ,$$

where ratio_energyₖ(f) represents the first ratio of the total energy within any one of the frequency bands of the first speech frame to the total energy of the first speech frame, a value of i is within 0˜f, f represents a quantity of spectral lines, fε[0,(Fₗᵢₘ−1)], (Fₗᵢₘ−1) represents a maximum value of the quantity of the spectral lines of the first speech frame, Re_fft(i) represents the real part of the first frequency-domain signal, Im_fft(i) represents the imaginary part of the first frequency-domain signal,

$${\sum }_{i = 0}^{( {F}_{lim} - 1 )} ( {Re\_fft}^{2} ( i ) + {Im\_fft}^{2} ( i ) )$$

represents the total energy of the first speech frame, and

$${\sum }_{i = 0}^{f} ( {Re\_fft}^{2} ( i ) + {Im\_fft}^{2} ( i ) )$$

represents total energy within a frequency range 0˜f of the first speech frame.

The energy distribution module 503 is further configured to perform the derivation on the first ratio according to

$${ratio\_energy}_{k}^{′} ( f ) = {( {\sum }_{n = 0}^{N} ( ( {\prod }_{{i = 0}_{i \neq n}}^{N} \frac{f - M - i}{n - i} ) * {ratio\_energy}_{k} ( n + M ) ) )}^{′} ,$$

where N represents that the foregoing numerical differentiation is N points, and M represents that the derivative value and is obtained using a first ratio within a range fε[M, (M+N−1)].

The correlation module 504 is configured to determine the frequency-domain energy correlation coefficient between the first speech frame and the second speech frame according to the first derivative within the frequency range of the first speech frame, a second derivative, and a product of the first derivative and the second derivative, where the second derivative represents the frequency-domain energy distribution of the second speech frame.

The correlation module 504 is further configured to determine a local maximum point of the frequency-domain energy correlation coefficient, group the original speech signal using the local maximum point as a grouping point, perform normalization processing on each group obtained by grouping, and calculate a corrected frequency-domain energy correlation coefficient according to the frequency-domain energy correlation coefficient and a result of the normalization processing. Correspondingly, segmenting the original speech signal according to the frequency-domain energy correlation coefficient includes segmenting the original speech signal according to the corrected frequency-domain energy correlation coefficient.

Further, the correlation module 504 is configured to calculate the corrected frequency-domain energy correlation coefficient according to a formula rₖ′=rₖ+(1−max(rₖ₁)), where rₖ′ is the calculated corrected frequency-domain energy correlation coefficient, rₖ is the frequency-domain energy correlation coefficient, rₖ₁ is a frequency-domain energy correlation coefficient of a local maximum point of each group after the grouping, and max(rₖ₁) is a maximum frequency-domain energy correlation coefficient of the local maximum point of each group after the grouping.

The correlation module 504 is further configured to calculate the correlation coefficient rₖ according to

$${r}_{k} = \frac{{F}_{lim} \cdot {sum}_{xy} ( k ) - {sum}_{x} ( k - 1 ) \cdot {sum}_{x} ( k )}{\begin{matrix}\sqrt{{F}_{lim} \cdot {sum}_{xx} ( k - 1 ) - {( {sum}_{x} ( k - 1 ) )}^{2}} \cdot \\ \sqrt{{F}_{lim} \cdot {sum}_{xx} ( k ) - {( {sum}_{x} ( k ) )}^{2}}\end{matrix}} , \\ k \geq 1 ,$$

where

$${sum}_{x} ( i ) = {\sum }_{f = 0}^{( {F}_{lim} - 1 )} {ratio\_energy}_{i}^{′} ( f ) , \\ {sum}_{xx} ( i ) = {\sum }_{f = 0}^{( {F}_{lim} - 1 )} {ratio\_energy}_{i}^{′} {( f )}^{2} ,$$

and

$${sum}_{xy} ( i ) = {\sum }_{f = 0}^{( {F}_{lim} - 1 )} [ {ratio\_energy}_{i - 1}^{′} ( f ) \cdot {ratio\_energy}_{i}^{′} ( f ) ] ,$$

where k−1 is the first speech frame, k is the second speech frame, and k is greater than or equal to 1.

Further, the segmentation module 505 is configured to determine a local minimum point of the frequency-domain energy correlation coefficient, and segment the speech signal using the local minimum point as a segmentation point when the local minimum point is less than or equal to a set threshold.

Optionally, the segmentation module 505 is further configured to calculate an average value of time-domain energy within a set time-domain range that uses each segmentation point in the original speech signal as a center, calculate whether the corresponding average value within the set time-domain range that uses each segmentation point as the center is less than or equal to a set value, and merge two segments involved by corresponding segmentation points when the corresponding average value within the set time-domain range that uses each segmentation point as the center is less than or equal to the set value.

In this embodiment, the apparatus for processing a speech signal according to frequency-domain energy first receives an original speech signal including a first speech frame and a second speech frame that are adjacent to each other, then, performs a Fourier transform on the first speech frame and the second speech frame to obtain a first frequency-domain signal and a second frequency-domain signal, then, obtains a frequency-domain energy distribution of the first speech frame and a frequency-domain energy distribution of the second speech frame accordingly, where the frequency-domain energy distribution is used to represent an energy distribution characteristic of the speech frame in a frequency domain, according to the frequency-domain energy distribution of the first speech frame and the frequency-domain energy distribution of the second speech frame, obtains a frequency-domain energy correlation coefficient that is between the first speech frame and the second speech frame and that is used to represent a spectral change from the first speech frame to the second speech frame, and finally, segments the original speech signal according to the frequency-domain energy correlation coefficient. In this way, the segmentation is performed using the frequency-domain energy distribution of the speech signal, thereby improving accuracy in segmenting the speech signal.

FIG. 13 is a schematic structural diagram of an apparatus for processing a speech signal according to frequency-domain energy according to Embodiment 5 of the present disclosure. As shown in FIG. 13, the apparatus for processing a speech signal according to frequency-domain energy includes a receiver 601 configured to receive an original speech signal, where the original speech signal includes a first speech frame and a second speech frame that are adjacent to each other, a processor 602 configured to perform a Fourier transform on the first speech frame to obtain a first frequency-domain signal, perform a Fourier transform on the second speech frame to obtain a second frequency-domain signal configured to obtain a frequency-domain energy distribution of the first speech frame according to the first frequency-domain signal, obtain a frequency-domain energy distribution of the second speech frame according to the second frequency-domain signal, where the frequency-domain energy distribution represents an energy distribution characteristic of the speech frame in a frequency domain configured to obtain a frequency-domain energy correlation coefficient between the first speech frame and the second speech frame according to the frequency-domain energy distribution of the first speech frame and the frequency-domain energy distribution of the second speech frame, where the frequency-domain energy correlation coefficient is used to represent a spectral change from the first speech frame to the second speech frame, and configured to segment the original speech signal according to the frequency-domain energy correlation coefficient.

Further, a frequency range of the first speech frame includes at least two frequency bands, and the processor 602 is configured to obtain a first ratio of total energy within any one of the frequency bands of the first speech frame to total energy of the first speech frame according to a real part of the first frequency-domain signal and an imaginary part of the first frequency-domain signal, and perform derivation on the first ratio to obtain a first derivative that represents the frequency-domain energy distribution of the first speech frame and the frequency-domain energy distribution of the second speech frame.

The processor 602 is further configured to obtain the first ratio according to

$${ratio\_energy}_{k} ( f ) = \frac{{\sum }_{i = 0}^{f} ( {Re\_fft}^{2} ( i ) + {Im\_fft}^{2} ( i ) )}{{\sum }_{i = 0}^{( {F}_{lim} - 1 )} ( {Re\_fft}^{2} ( i ) + {Im\_fft}^{2} ( i ) )} \times 100 \% , \\ f ∈ [ 0 , ( {F}_{lim} - 1 ) ] ,$$

where ratio_energyₖ(f) represents the first ratio of the total energy within any one of the frequency bands of the first speech frame to the total energy of the first speech frame, a value of i is within 0˜f, f represents a quantity of spectral lines, fε[0, (Fₗᵢₘ−1)], (Fₗᵢₘ−1) represents a maximum value of the quantity of the spectral lines of the first speech frame, Re_fft(i) represents the real part of the first frequency-domain signal, Im_fft(i) represents the imaginary part of the first frequency-domain signal,

$${\sum }_{i = 0}^{( {F}_{lim} - 1 )} ( {Re\_fft}^{2} ( i ) + {Im\_fft}^{2} ( i ) )$$

represents the total energy of the first speech frame, and

$${\sum }_{i = 0}^{f} ( {Re\_fft}^{2} ( i ) + {Im\_fft}^{2} ( i ) )$$

represents total energy within a frequency range 0˜f of the first speech frame.

Further, the processor 602 is further configured to perform the derivation on the first ratio according to

$${ratio\_energy}_{k}^{′} ( f ) = {( {\sum }_{n = 0}^{N} ( ( {\prod }_{{i = 0}_{i \neq n}}^{N} \frac{f - M - i}{n - i} ) * {ratio\_energy}_{k} ( n + M ) ) )}^{′} ,$$

where N represents that the foregoing numerical differentiation is N points, and M represents that the derivative value and is obtained using a first ratio within a range fε[M, (M+N−1)].

Further, the processor 602 is configured to determine the frequency-domain energy correlation coefficient between the first speech frame and the second speech frame according to the first derivative within the frequency range of the first speech frame, a second derivative, and a product of the first derivative and the second derivative, where the second derivative represents the frequency-domain energy distribution of the second speech frame.

Further, the processor 602 is configured to calculate the corrected frequency-domain energy correlation coefficient according to a formula rₖ′=rₖ+(1−max(rₖ₁)), where rₖ′ is the calculated corrected frequency-domain energy correlation coefficient, rₖ is the frequency-domain energy correlation coefficient, rₖ₁ is a frequency-domain energy correlation coefficient of a local maximum point of each group after the grouping, and max(rₖ₁) is a maximum frequency-domain energy correlation coefficient of the local maximum point of each group after the grouping.

The processor 602 is further configured to determine a local maximum point of the frequency-domain energy correlation coefficient, group the original speech signal using the local maximum point as a grouping point, perform normalization processing on each group obtained by grouping, and calculate a corrected frequency-domain energy correlation coefficient according to the frequency-domain energy correlation coefficient and a result of the normalization processing. Correspondingly, the segmenting the original speech signal according to the frequency-domain energy correlation coefficient includes segmenting the original speech signal according to the corrected frequency-domain energy correlation coefficient.

Further, the processor 602 is further configured to calculate the correlation coefficient

$${r}_{k} according to$$

$${r}_{k} = \frac{{F}_{lim} \cdot {sum}_{xy} ( k ) - {sum}_{x} ( k - 1 ) \cdot {sum}_{x} ( k )}{\begin{matrix}\sqrt{{F}_{lim} \cdot {sum}_{xx} ( k - 1 ) - {( {sum}_{x} ( k - 1 ) )}^{2}} \cdot \\ \sqrt{{F}_{lim} \cdot {sum}_{xx} ( k ) - {( {sum}_{x} ( k ) )}^{2}}\end{matrix}} , \\ k \geq 1 ,$$

where

$${sum}_{x} ( i ) = {\sum }_{f = 0}^{( {F}_{lim} - 1 )} {ratio\_energy}_{i}^{′} ( f ) , \\ {sum}_{xx} ( i ) = {\sum }_{f = 0}^{( {F}_{lim} - 1 )} {ratio\_energy}_{i}^{′} {( f )}^{2} ,$$

and

$${sum}_{xy} ( i ) = {\sum }_{f = 0}^{( {F}_{lim} - 1 )} [ {ratio\_energy}_{i - 1}^{′} ( f ) \cdot {ratio\_energy}_{i}^{′} ( f ) ] ,$$

where k−1 is the first speech frame, k is the second speech frame, and k is greater than or equal to 1.

Further, the processor 602 is configured to determine a local minimum point of the frequency-domain energy correlation coefficient, and segment the speech signal using the local minimum point as a segmentation point when the local minimum point is less than or equal to a set threshold.

Optionally, the processor 602 is further configured to calculate an average value of time-domain energy within a set time-domain range that uses each segmentation point in the original speech signal as a center, and merge two segments involved by corresponding segmentation points when the calculated corresponding average value within the set time-domain range that uses each segmentation point as the center is less than or equal to a set value.

In this embodiment, a receiver in the apparatus for processing a speech signal according to frequency-domain energy first receives an original speech signal including a first speech frame and a second speech frame that are adjacent to each other, then, a processor performs a Fourier transform on the first speech frame and the second speech frame to obtain a first frequency-domain signal and a second frequency-domain signal, obtains a frequency-domain energy distribution of the first speech frame and a frequency-domain energy distribution of the second speech frame accordingly, where the frequency-domain energy distribution is used to represent an energy distribution characteristic of the speech frame in a frequency domain, obtains a frequency-domain energy correlation coefficient that is between the first speech frame and the second speech frame and that is used to represent a spectral change from the first speech frame to the second speech frame according to the frequency-domain energy distribution of the first speech frame and the frequency-domain energy distribution of the second speech frame, and finally, segments the original speech signal according to the frequency-domain energy correlation coefficient. In this way, the segmentation is performed using the frequency-domain energy distribution of the speech signal, thereby improving accuracy in segmenting the speech signal.

A person of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present disclosure.

What is claimed is:

1. A method for processing a speech signal according to frequency-domain energy, comprising:
receiving an original speech signal, wherein the original speech signal comprises a first speech frame and a second speech frame that are adjacent to each other;
performing a Fourier transform on the first speech frame to obtain a first frequency-domain signal;
performing the Fourier transform on the second speech frame to obtain a second frequency-domain signal;
obtaining a frequency-domain energy distribution of the first speech frame according to the first frequency-domain signal;
obtaining a frequency-domain energy distribution of the second speech frame according to the second frequency-domain signal, wherein the frequency-domain energy distribution represents an energy distribution characteristic of the speech frame in a frequency domain;
obtaining a frequency-domain energy correlation coefficient between the first speech frame and the second speech frame according to the frequency-domain energy distribution of the first speech frame and the frequency-domain energy distribution of the second speech frame, wherein the frequency-domain energy correlation coefficient is used to represent a spectral change from the first speech frame to the second speech frame; and
segmenting the original speech signal according to the frequency-domain energy correlation coefficient.

2. The method according to claim 1, wherein a frequency range of the first speech frame comprises at least two frequency bands, and wherein obtaining the frequency-domain energy distribution of the first speech frame according to the first frequency-domain signal comprises:
obtaining a first ratio of total energy within any one of the frequency bands of the first speech frame to total energy of the first speech frame according to a real part of the first frequency-domain signal and an imaginary part of the first frequency-domain signal; and
performing derivation on the first ratio to obtain a first derivative that represents the frequency-domain energy distribution of the first speech frame.

3. The method according to claim 2, wherein obtaining the frequency-domain energy correlation coefficient between the first speech frame and the second speech frame according to the frequency-domain energy distribution of the first speech frame and the frequency-domain energy distribution of the second speech frame comprises determining the frequency-domain energy correlation coefficient between the first speech frame and the second speech frame according to the first derivative within the frequency range of the first speech frame, a second derivative, and a product of the first derivative and the second derivative, wherein the second derivative represents the frequency-domain energy distribution of the second speech frame.

4. The method according to claim 1, wherein after obtaining the frequency-domain energy correlation coefficient between the first speech frame and the second speech frame according to the frequency-domain energy distribution of the first speech frame and the frequency-domain energy distribution of the second speech frame, the method further comprises:
determining a local maximum point of the frequency-domain energy correlation coefficient;
grouping the original speech signal using the local maximum point as a grouping point;
performing normalization processing on each group obtained by grouping; and
calculating a corrected frequency-domain energy correlation coefficient according to the frequency-domain energy correlation coefficient and a result of the normalization processing, and
wherein segmenting the original speech signal according to the frequency-domain energy correlation coefficient comprises segmenting the original speech signal according to the corrected frequency-domain energy correlation coefficient.

5. The method according to claim 4, wherein calculating the corrected frequency-domain energy correlation coefficient according to the frequency-domain energy correlation coefficient and the result of the normalization processing further comprises calculating the corrected frequency-domain energy correlation coefficient according to a formula:
rₖ′=rₖ+(1−max(rₖ₁)),
wherein the rₖ′ is the calculated corrected frequency-domain energy correlation coefficient, wherein the rₖ is the frequency-domain energy correlation coefficient, wherein the rₖ₁ is a frequency-domain energy correlation coefficient of a local maximum point of each group after the grouping, and wherein the max(rₖ₁) is a maximum frequency-domain energy correlation coefficient of the local maximum point of each group after the grouping.

6. The method according to claim 1, wherein segmenting the original speech signal according to the frequency-domain energy correlation coefficient comprises:
determining a local minimum point of the frequency-domain energy correlation coefficient; and
segmenting the original speech signal using the local minimum point as a segmentation point when the local minimum point is less than or equal to a set threshold.

7. The method according to claim 6, wherein after segmenting the original speech signal according to the frequency-domain energy correlation coefficient, the method further comprises:
calculating an average value of time-domain energy within a set time-domain range that uses each segmentation point in the original speech signal as a center; and
merging two segments involved by corresponding segmentation points when the calculated corresponding average value within the set time-domain range that uses each segmentation point as the center is less than or equal to a set value.

8. The method according to claim 2, wherein obtaining the first ratio of the total energy within any one of the frequency bands of the first speech frame to the total energy of the first speech frame according to the real part of the first frequency-domain signal and the imaginary part of the first frequency-domain signal comprises obtaining the first ratio according to:
$${ratio\_energy}_{k} ( f ) = \frac{{\sum }_{i = 0}^{f} ( {Re\_fft}^{2} ( i ) + {Im\_fft}^{2} ( i ) )}{{\sum }_{i = 0}^{( {F}_{lim} - 1 )} ( {Re\_fft}^{2} ( i ) + {Im\_fft}^{2} ( i ) )} \times 100 \% ,$$
wherein the ratio_energyₖ(f) represents the first ratio of the total energy within any one of the frequency bands of the first speech frame to the total energy of the first speech frame, wherein a value of the i is within 0˜f, wherein the f represents a quantity of spectral lines, wherein the fε[0, (Fₗᵢₘ−1)], wherein the (Fₗᵢₘ−1) represents a maximum value of the quantity of the spectral lines of the first speech frame, wherein the Re_fft(i) represents the real part of the first frequency-domain signal, wherein the Im_fft(i) represents the imaginary part of the first frequency-domain signal, wherein the
$${\sum }_{i = 0}^{( {F}_{lim} - 1 )} ( {Re\_fft}^{2} ( i ) + {Im\_fft}^{2} ( i ) )$$
represents the total energy of the first speech frame, and wherein the
$${\sum }_{i = 0}^{f} ( {Re\_fft}^{2} ( i ) + {Im\_fft}^{2} ( i ) )$$
represents total energy within a frequency range 0˜f of the first speech frame.

9. The method according to claim 8, wherein performing derivation on the first ratio comprises performing the derivation on the first ratio according to:
$${ratio\_energy}_{k}^{′} ( f ) = {( {\sum }_{n = 0}^{N} ( ( {\prod }_{{i = 0}_{i \neq n}}^{N} \frac{f - M - i}{n - i} ) ⋆ {ratio\_energy}_{k} ( n + M ) ) )}^{′} ,$$
wherein the N represents that the foregoing numerical differentiation is N points, and wherein M represents the derivative value and is obtained using a first ratio within a range fε[M,(M+N−1)].

10. The method according to claim 9, wherein obtaining the frequency-domain energy correlation coefficient between the first speech frame and the second speech frame according to the frequency-domain energy distribution of the first speech frame and the frequency-domain energy distribution of the second speech frame comprises calculating the frequency-domain energy correlation coefficient rₖ according to:
$${r}_{k} = \frac{{F}_{lim} \cdot {sum}_{xy} ( k ) - {sum}_{x} ( k - 1 ) \cdot {sum}_{x} ( k )}{\sqrt{{F}_{lim} \cdot {sum}_{xx} ( k - 1 ) - {( {sum}_{x} ( k - 1 ) )}^{2} \cdot \sqrt{{F}_{lim} \cdot {sum}_{xx} ( k ) - {( {sum}_{x} ( k ) )}^{2}}}} ,$$
wherein the
$${sum}_{x} ( i ) = {\sum }_{f = 0}^{( {F}_{lim} - 1 )} {ratio\_energy}_{i}^{′} ( f ) ,$$
wherein the
$${sum}_{xx} ( i ) = {\sum }_{f = 0}^{( {F}_{lim} - 1 )} {ratio\_energy}_{i}^{′} {( f )}^{2} ,$$
wherein the
$${sum}_{xy} ( i ) = {\sum }_{f = 0}^{( {F}_{lim} - 1 )} [ {ratio\_energy}_{i - 1}^{′} ( f ) \cdot {ratio\_energy}_{i}^{′} ( f ) ] ,$$
wherein the k−1 represents the first speech frame, wherein the k represents the second speech frame, and wherein the k is greater than or equal to 1.

11. An apparatus for processing a speech signal according to frequency-domain energy, comprising:
a receiver configured to receive an original speech signal, wherein the original speech signal comprises a first speech frame and a second speech frame that are adjacent to each other; and
a processor coupled to the receiver and configured to:
perform a Fourier transform on the first speech frame to obtain a first frequency-domain signal;
perform the Fourier transform on the second speech frame to obtain a second frequency-domain signal;
obtain a frequency-domain energy distribution of the first speech frame according to the first frequency-domain signal;
obtain a frequency-domain energy distribution of the second speech frame according to the second frequency-domain signal, wherein the frequency-domain energy distribution represents an energy distribution characteristic of the speech frame in a frequency domain;
obtain a frequency-domain energy correlation coefficient between the first speech frame and the second speech frame according to the frequency-domain energy distribution of the first speech frame and the frequency-domain energy distribution of the second speech frame, wherein the frequency-domain energy correlation coefficient is used to represent a spectral change from the first speech frame to the second speech frame; and
segment the original speech signal according to the frequency-domain energy correlation coefficient.

12. The apparatus according to claim 11, wherein a frequency range of the first speech frame comprises at least two frequency bands, wherein the processor is further configured to:
obtain a first ratio of total energy within any one of the frequency bands of the first speech frame to total energy of the first speech frame according to a real part of the first frequency-domain signal and an imaginary part of the first frequency-domain signal; and
perform derivation on the first ratio to obtain a first derivative that represents the frequency-domain energy distribution of the first speech frame.

13. The apparatus according to claim 11, wherein the processor is further configured to determine the frequency-domain energy correlation coefficient between the first speech frame and the second speech frame according to a first derivative within a frequency range of the first speech frame, a second derivative, and a product of the first derivative and the second derivative, wherein the second derivative represents the frequency-domain energy distribution of the second speech frame.

14. The apparatus according to claim 11, wherein the processor is further configured to:
determine a local maximum point of the frequency-domain energy correlation coefficient;
group the original speech signal using the local maximum point as a grouping point;
perform normalization processing on each group obtained by grouping;
calculate a corrected frequency-domain energy correlation coefficient according to the frequency-domain energy correlation coefficient and a result of the normalization processing; and
segment the original speech signal according to the corrected frequency-domain energy correlation coefficient.

15. The apparatus according to claim 14, wherein the processor is further configured to calculate the corrected frequency-domain energy correlation coefficient according to a formula:
rₖ′=rₖ+(1−max(rₖ₁)),
wherein the rₖ′ is the calculated corrected frequency-domain energy correlation coefficient, wherein the rₖ is the frequency-domain energy correlation coefficient, wherein the rₖ₁ is a frequency-domain energy correlation coefficient of a local maximum point of each group after the grouping, and wherein the max(rₖ₁) is a maximum frequency-domain energy correlation coefficient of the local maximum point of each group after the grouping.

16. The apparatus according to claim 11, wherein the processor is further configured to:
determine a local minimum point of the frequency-domain energy correlation coefficient; and
segment the original speech signal using the local minimum point as a segmentation point when the local minimum point is less than or equal to a set threshold.

17. The apparatus according to claim 16, wherein the processor is further configured to:
calculate an average value of time-domain energy within a set time-domain range that uses each segmentation point in the original speech signal as a center; and
merge two segments involved by corresponding segmentation points when the calculated corresponding average value within the set time-domain range that uses each segmentation point as the center is less than or equal to a set value.

18. The apparatus according to claim 12, wherein the processor is further configured to obtain the first ratio according to:
$${ratio\_energy}_{k} ( f ) = \frac{{\sum }_{i = 0}^{f} ( {Re\_fft}^{2} ( i ) + {Im\_fft}^{2} ( i ) )}{{\sum }_{i = 0}^{( {F}_{lim} - 1 )} ( {Re\_fft}^{2} ( i ) + {Im\_fft}^{2} ( i ) )} \times 100 \% ,$$
wherein the ratio_energyₖ(f) represents the first ratio of the total energy within any one of the frequency bands of the first speech frame to the total energy of the first speech frame, wherein a value of the i is within 0˜f, wherein the f represents a quantity of spectral lines, wherein the fε[0, (Fₗᵢₘ−1)], wherein the (Fₗᵢₘ−1) represents a maximum value of the quantity of the spectral lines of the first speech frame, wherein the Re_fft(i) represents the real part of the first frequency-domain signal, wherein the Im_fft(i) represents the imaginary part of the first frequency-domain signal, wherein the
$${\sum }_{i = 0}^{( {F}_{lim} - 1 )} ( {Re\_fft}^{2} ( i ) + {Im\_fft}^{2} ( i ) )$$
represents the total energy of the first speech frame, and wherein the
$${\sum }_{i = 0}^{f} ( {Re\_fft}^{2} ( i ) + {Im\_fft}^{2} ( i ) )$$
represents total energy within a frequency range 0˜f of the first speech frame.

19. The apparatus according to claim 13, wherein the processor is further configured to perform the derivation on the first ratio according to:
$${ratio\_energy}_{k}^{′} ( f ) = {( {\sum }_{n = 0}^{N} ( ( {\prod }_{{i = 0}_{i \neq n}}^{N} \frac{f - M - i}{n - i} ) ⋆ {ratio\_energy}_{k} ( n + M ) ) )}^{′} ,$$
wherein the N represents that the foregoing numerical differentiation is N points, and wherein the M represents that the derivative value and is obtained using a first ratio within a range fε[M,(M+N−1)].

20. The apparatus according to claim 19, wherein the processor is further configured to calculate the frequency-domain energy correlation coefficient rₖ according to:
$${r}_{k} = \frac{{F}_{lim} \cdot {sum}_{xy} ( k ) - {sum}_{x} ( k - 1 ) \cdot {sum}_{x} ( k )}{\sqrt{{F}_{lim} \cdot {sum}_{xx} ( k - 1 ) - {( {sum}_{x} ( k - 1 ) )}^{2} \cdot \sqrt{{F}_{lim} \cdot {sum}_{xx} ( k ) - {( {sum}_{x} ( k ) )}^{2}}}} ,$$
wherein the
$${sum}_{x} ( i ) = {\sum }_{f = 0}^{( {F}_{lim} - 1 )} {ratio\_energy}_{i}^{′} ( f ) ,$$
wherein the
$${sum}_{xx} ( i ) = {\sum }_{f = 0}^{( {F}_{lim} - 1 )} {ratio\_energy}_{i}^{′} {( f )}^{2} ,$$
wherein the
$${sum}_{xy} ( i ) = {\sum }_{f = 0}^{( {F}_{lim} - 1 )} [ {ratio\_energy}_{i - 1}^{′} ( f ) \cdot {ratio\_energy}_{i}^{′} ( f ) ] ,$$
wherein the k−1 is the first speech frame, wherein the k is the second speech frame, and wherein the k is greater than or equal to 1.
